(19) United States
(12) Patent Application Publication
(10) Pub. No.: US 2024/0345771 A1
(43) Pub. Date: Oct. 17, 2024

(54) CONTROLLER, STORAGE DEVICE AND COMPUTING SYSTEM

(71) Applicant: SK hynix Inc., Gyeonggi-do (KR)

(72) Inventor: Chi Je PARK, Gyeonggi-do (KR)

(21) Appl. No.: 18/465,159

(22) Filed: Sep. 12, 2023

(30) Foreign Application Priority Data
Apr. 13, 2023 (KR) 10-2023-0048690

(51) Int. Cl. G06F 3/06

(52) U.S. Cl. CPC G06F 3/0659; G06F 3/0608; G06F 3/0656; G06F 3/0673

(57) ABSTRACT

According to embodiments of the present disclosure, a storage device may externally provide device information according to a memory state associated with a memory operation performed by an internal command during an idle period, and operate in an idle mode according to an idle period set according to the memory state.

### CROSS-REFERENCE TO RELATED APPLICATION

The present application claims priority under 35 U.S.C. 119 (a) to Korean patent application number 10-2023-0048690 filed on Apr. 13, 2023, which is incorporated herein by reference in its entirety.

### TECHNICAL FIELD

The embodiments of the present disclosure relate to a controller, a storage device, and a computing system.

### BACKGROUND

A storage device may include a memory including a plurality of memory cells for storing data. In addition, a storage device may include a controller which controls an operation of the memory. The controller may control the operation of the memory based on an external command input from an external device or an internal command output by the controller.

In order to efficiently operate a storage device, there is required a method for efficiently managing a period during which a memory operation is performed and a period during which a memory operation is not performed according to an external command or an internal command.

### SUMMARY

Embodiments of the present disclosure may provide a configuration capable of controlling an idle mode of a storage device based on a memory state related to memory operations performed according to internal commands.

In one aspect, embodiments of the present disclosure may provide a storage device including a memory, and a controller configured to control an operation of the memory according to an external command or an internal command, set device information based on a state of the memory, the state being associated with the operation according to the internal command and transmit the device information to an external device, and receive an idle mode control signal corresponding to the device information.

In another aspect, embodiments of the present disclosure may provide a computing system including a storage device configured to control, according to an external command or an internal command, an operation of a memory included therein, set device information based on a state of the memory, the state being associated with the operation according to the internal command, and transmit the device information to a host device, wherein the host device configured to set an idle period corresponding to the device information, and transmit, to the storage device, an idle mode control signal indicating the idle period.

In another aspect, embodiments of the present disclosure may provide a controller including a device information configuration module configured to set device information based on a state of a memory, the state being associated with an operation of the memory and the operation being performed according to an internal command, a data signal transmission module configured to transmit the device information to an external device, and a control signal reception module configured to receive an idle mode control signal corresponding to the device information.

According to embodiments of the present disclosure, an idle mode or a sleep mode may be controlled in response to a memory state associated with a memory operation performed according to an internal command, so that it is possible to improve the operating efficiency of a storage device operating according to an external command or an internal command.

### BRIEF DESCRIPTION OF THE DRAWINGS

FIG. 1 is a schematic diagram illustrating a configuration of a storage device according to the embodiments of the present disclosure.

FIG. 2 illustrates an example of a schematic configuration of a computing system including a storage device and a host device according to embodiments of the present disclosure.

FIGS. 3 to 5 illustrate examples of an operation of a storage device in an idle mode according to embodiments of the present disclosure.

FIGS. 6 to 9 illustrate examples of a type of device information transmitted by a storage device and an idle period based on the device information according to embodiments of the present disclosure.

FIG. 10 illustrates an example of a method of transmitting device information by a storage device according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is described that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are described, it should be considered that numerical values for elements or features, or corresponding information (e.g., level, range, etc.) include a tolerance or an error range that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

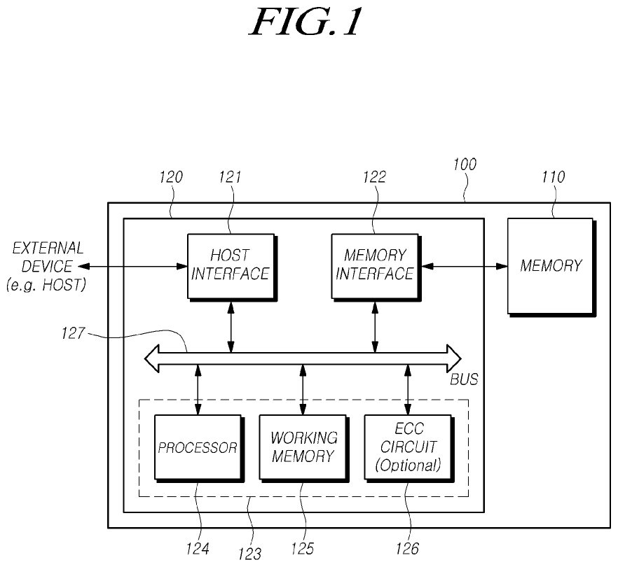

FIG. 1 is a schematic diagram illustrating a configuration of a storage device 100 according to the embodiments of the present disclosure.

Referring to FIG. 1, the storage device 100 may include a memory 110 for storing data, and a controller 120 for controlling the memory 110.

The memory 110 may include a plurality of memory blocks and may operate in response to control of the controller 120. An operation of the memory 110 may include, for example, a read operation, a program operation (also referred to as a “write operation”), and an erase operation.

The memory 110 may include a memory cell array including a plurality of memory cells (also referred to simply as “cells”) storing data. Such a memory cell array may exist in a memory block.

For example, the memory 110 may be implemented in a variety of types of a NAND flash memory, a 3D NAND flash memory, a NOR flash memory, a resistive RAM, a phase change memory, a magneto-resistive memory, a ferroelectric memory, or a spin injection magnetization inversion memory.

The memory 110 may be implemented in a three-dimensional array structure. Embodiments of the present disclosure may be applied not only to a flash memory in which a charge storage layer is composed of a conductive floating gate, but also to a flash memory of a charge trap type (CTF) in which a charge storage layer is composed of an insulating film.

The memory 110 may receive a command and an address from the controller 120 and access an area selected by the address in the memory cell array. The memory 110 may perform an operation indicated by a command on an area selected by an address.

For example, the memory 110 may perform a program operation, a read operation, and an erase operation.

When performing a program operation, the memory 110 may program data in an area selected by an address. When performing a read operation, the memory 110 may read data from an area selected by an address. When performing the erase operation, the memory 110 may erase data stored in an area selected by an address.

The controller 120 may control write (program), read, erase, and background operations of the memory 110. The background operations may include, for example, one or more of garbage collection (GC), wear leveling (WL), read reclaim (RR), or bad block management (BBM) operations.

The controller 120 may control the operation of the memory 110 according to a request of an external device such as a host HOST. In addition, the controller 120 may control the operation of the memory 110 regardless of a request from the host HOST.

The host may be a computer, UMPC (Ultra Mobile PC), workstation, PDA (Personal Digital Assistants), tablet, mobile phone, smartphone, e-book, PMP (Portable Multimedia Player), portable game device, a navigation device, a black box, a digital camera, DMB (Digital Multimedia Broadcasting) players, smart televisions, digital voice recorders, digital voice players, digital video recorders, digital video players, digital video recorders, digital video players, storage constituting data centers, one of various electronic devices constituting a home network, one of various electronic devices constituting a computer network, one of various electronic devices constituting a telematics network, an RFID (Radio Frequency IDentification) device, and a mobile device (e.g., a vehicle, a robot, a drone) capable of driving under human control or autonomous driving. Alternatively, the host may be a virtual/augmented reality device providing a 2D or 3D virtual reality image or augmented reality image. The host may be any of various electronic devices which require a storage device 100 capable of storing data.

The host may include at least one operating system. The operating system may manage and control overall functions and operations of the host and provide mutual operations between the host and the storage device 100. The operating system may be divided into a general operating system and a mobile operating system depending on the mobility of the host.

The controller 120 and the host may be separate devices. In some cases, the controller 120 and the host may be implemented as an integrated device. In the following, for convenience of description, an example will be described in which the controller 120 and the host are separate devices.

Referring to FIG. 1, the controller 120 may include a memory interface 122, a control circuit 123, and the like, and may further include a host interface 121.

The host interface 121 provides an interface for communication with the host. For example, the host interface 121 may provide a communication standard or interface using at least one of an universal serial bus (USB) protocol, a multimedia card (MMC) protocol, a peripheral component interconnection (PCI) protocol, a PCI-express (PCI-e or PCIe) protocol, and an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a system management bus (SMBus) protocol, an inter-integrated circuit (I2C) protocol, an improved inter-integrated circuit (I3C) protocol, and a private protocol.

When receiving a command from the host, the control circuit 123 may receive the command through the host interface 121 and perform an operation of processing the received command.

The memory interface 122 may be connected to the memory 110 to provide an interface for communication with the memory 110.

The memory interface 122 may be configured to provide an interface between the memory 110 and the controller 120 in response to control of the control circuit 123.

The control circuit 123 may control the operation of the memory 110 by performing overall control operations of the controller 120. For example, the control circuit 123 may include one or more of a processor 124, a working memory 125, and the like, and may optionally include an error detection and correction circuit (ECC Circuit, 126) and the like.

The processor 124 may control overall operations of the controller 120 and perform logical operations. The processor 124 may communicate with the host through the host interface 121 and may communicate with the memory 110 through the memory interface 122.

The processor 124 may perform a function of a flash translation layer (FTL). The processor 124 may convert a logical block address (LBA) provided by the host into a physical block address (PBA) through a flash translation layer (FTL). The flash translation layer (FTL) may receive a logical block address (LBA) by using a mapping table and convert it into a physical block address (PBA).

There are various methods of address mapping the flash translation layer according to mapping units. The address mapping methods may include a page mapping method, a block mapping method, and a mixed mapping method.

The processor 124 may randomize data received from the host. For example, the processor 124 may randomize data received from the host using the preset randomizing seed. Randomized data may be provided to the memory 110 and programmed into a memory cell array of the memory 110.

The processor 124 may derandomize data received from the memory 110 during a read operation. For example, the processor 124 may derandomize data received from the memory 110 using the derandomizing seed. The derandomized data may be output to the host.

The processor 124 may control the operation of the controller 120 by executing firmware. The processor 124 may execute (drive) firmware loaded into the working memory 125 during booting in order to control the overall operation of the controller 120 and perform logical operations. Hereinafter, an operation of the storage device 100 described in embodiments of the present disclosure may be implemented in a manner in which the processor 124 executes firmware defining a corresponding operation.

The firmware may be a program executed in the storage device 100 to drive the storage device 100, and may include various functional layers. For example, the firmware may include binary data defining codes for executing each of the aforementioned functional layers.

For example, the firmware may include at least one of a flash translation layer (FTL) for performing a conversion function between a logical address requested by the host to the storage device 100 and a physical address of the memory 110, a host interface layer (HIL) for interpreting a command requested by the host to the storage device 100 and delivering it to a flash translation layer (FTL), and a flash interface layer (FIL) for transferring commands instructed by the flash translation layer (FTL) to the memory 110.

Such firmware, for example, may be loaded into the working memory 125 from the memory 110 or from a separate memory (e.g., ROM, NOR Flash) located outside the memory 110. When executing a booting operation after power-on, the processor 124 may first load all or part of the firmware into the working memory 125.

The processor 124 may perform logic operations defined in firmware loaded in the working memory 125 to control the overall operation of the controller 120. The processor 124 may store a result of performing a logic operation defined in firmware in the working memory 125. The processor 124 may control the controller 120 to generate a command or signal according to a result of performing a logic operation defined in firmware. If the part of the firmware defining the logic operation to be performed is not loaded in the working memory 125, the corresponding part of the firmware may be loaded into the working memory 125.

The processor 124 may load meta data necessary for driving the firmware from the memory 110. Meta data is data for managing the memory 110 and may include management information about user data stored in the memory 110.

The firmware may be updated while the storage device 100 is being produced or while the storage device 100 is running. The controller 120 may download new firmware from the outside of the storage device 100 and update the existing firmware to the new firmware.

The working memory 125 may store firmware, program codes, commands, or data required to operate the controller 120. The working memory 125, as a volatile memory, may include, for example, one or more of static RAM (SRAM), dynamic RAM (DRAM), and synchronous DRAM (SDRAM).

The error detection and correction circuit 126 may detect an error bit of target data using an error correction code and correct the detected error bit. The target data may be, for example, data stored in the working memory 125 or data read from the memory 110.

The error detection and correction circuit 126 may be implemented to decode data with an error correction code. The error detection and correction circuit 126 may be implemented with a variety of code decoders. For example, a decoder performing non-systematic code decoding or a decoder performing systematic code decoding may be used.

For example, the error detection and correction circuit 126 may detect an error bit in units of sectors set for each of the read data. Each read data may be composed of a plurality of sectors. A sector may refer to a data unit smaller than a page, which is a read unit of a flash memory. Sectors constituting each read data may correspond to each other by using an address.

The error detection and correction circuit 126 may calculate a bit error rate (BER) and determine the possibility of correction in units of sectors. For example, the error detection and correction circuit 126 may determine that the corresponding sector is uncorrectable or failed if the bit error rate is higher than a set reference value. On the other hand, if the bit error rate is lower than the reference value, the corresponding sector may be determined to be correctable or pass.

The error detection and correction circuit 126 may sequentially perform error detection and correction operations on all read data. If a sector included in read data is correctable, the error detection and correction circuit 126 may skip an error detection and correction operation for a corresponding sector for next read data. If the error detection and correction operations for all read data are completed in this way, the error detection and correction circuit 126 may detect sectors determined to be uncorrectable until the end. The number of sectors determined to be uncorrectable may be one or more. The error detection and correction circuit 126 may transfer information (e.g., address information) on a sector determined to be uncorrectable to the processor 124.

A bus 127 may be configured to provide a channel between components 121, 122, 124, 125, and 126 of controller 120. The bus 127 may include, for example, a control bus for transferring various control signals, commands, and the like, and a data bus for transferring various data.

Some of the above-described components 121, 122, 124, 125, and 126 of the controller 120 may be deleted, or some of the above-described components 121, 122, 124, 125 and 126 may be integrated into one element. In some cases, one or more other components may be added in addition to the above-described components of the controller 120.

The storage device 100 may operate in an idle mode or a sleep mode according to a signal input from the outside. The storage device 100 may transmit information about the state of the memory 110 included in the storage device 100 to the outside and operate in an idle mode or a sleep mode corresponding to the information.

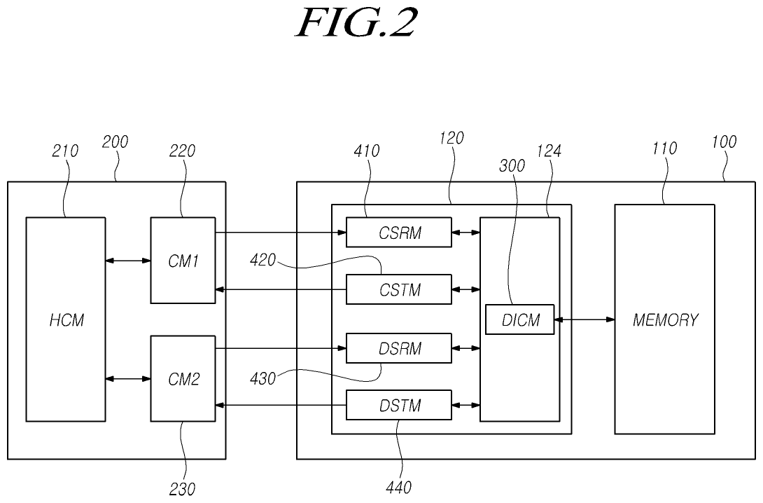

FIG. 2 illustrates an example of a schematic configuration of a computing system including a storage device 100 and a host device 200 according to embodiments of the present disclosure.

FIG. 2 illustrates a configuration for transmitting, to the outside, information about the state of the memory 110 and receiving a control signal corresponding to the information among the configurations of the storage device 100.

The storage device 100 may include a memory 110 and a controller 120 which controls an operation of the memory 110.

The controller 120 may include a processor 124 and at least one signal transmission/reception module.

The processor 124 may include, for example, a device information configuration module 300. The device information configuration module 300 may be implemented in firmware and loaded into the processor 124, or may be implemented in a logic form and included in the processor 124.

The signal transmission/reception module included in the controller 120 may include, for example, a control signal reception module 410, a control response signal transmission module 420, a data signal reception module 430, and a data signal transmission module 440. In some cases, two or more signal transmission/reception modules may be implemented as one module.

The control signal reception module 410 and the control response signal transmission module 420 may, for example, transmit and receive signals to and from a first communication module 220 included in the host device 200. The data signal reception module 430 and the data signal transmission module 440 may transmit and receive signals to and from a second communication module 230 included in the host device 200, for example.

The first communication module 220 and the second communication module 230 included in the host device 200 may be controlled by a host control module 210, for example.

An idle mode control signal, a sleep mode setting signal, and the like may be transmitted and received through the first communication module 220 under the control of the host control module 210. A command unit and a response unit may be transmitted and received through the second communication module 230 under the control of the host control module 210.

For example, the command unit may be transmitted to the data signal reception module 430 of the storage device 100 through the second communication module 230 of the host device 200. The command unit may include, for example, a command instructing an operation to be performed in the memory 110. In some cases, the command unit may include data to be programmed into the memory 110 if a command included in the command unit is a program command.

A command included in the command unit transmitted by the host device 200 may be referred to as an external command.

The storage device 100 may transmit the response unit in response to the command unit to the second communication module 230 of the host device 200 through the data signal transmission module 440.

The storage device 100 may include the device information in the response unit and transmit the response unit to the host device 200.

The device information may be set by the device information configuration module 300. The device information may include information related to a state of the memory 110 included in the storage device 100.

The device information may include, for example, information about a state of the memory 110 associated with an operation of the memory 110 that may be performed during an idle period. The idle period may be a period in which a command unit is not input by the host device 200 or may be a period in which control is performed in an idle mode according to a signal output from the host device 200.

The device information may include, for example, information about a state of the memory 110 associated with an operation of the memory 110 that may be performed by an internal command. Unlike an external command, the internal command may refer to a command output by the controller 120.

An operation of the memory 110 performed by an internal command may be, for example, an operation related to a write booster.

The memory cells included in the memory 110 may operate as single-level cells which store 1-bit data, may operate as multi-level cells which store 2-bit data, or may operate as triple-level cells which store 3-bit data. In order to speed up the operation of the storage device 100, the controller 120 may perform an operation of first storing data in the single-level cells, and transferring data stored in single-level cells to multi-level cells or triple-level cells for a predetermined period. This operation may be referred to as a write booster operation or a write booster flush operation.

A period required for performing this operation may vary depending on a remaining capacity of a write booster buffer composed of single-level cells. The device information may be set based on the remaining capacity of the write booster buffer.

The operation of the memory 110 that can be performed by an internal command may be, as another example, an operation related to garbage collection.

A level at which garbage collection for the memory 110 is required may be indicated by a dirty level. For example, the higher the dirty level, the greater the need for garbage collection or the greater the time required to perform garbage collection.

The device information may be set based on a dirty level indicating a level at which garbage collection is required.

Alternatively, in addition to the above example, the device information may be set according to a state of the memory 110 associated with an operation of the memory 110 performed by an internal command output by the controller 120.

The storage device 100 may transmit, to the host device 200 through the data signal transmission module 440, the device information set by the device information configuration module 300.

The host device 200 may check the state of the memory 110 according to the device information. The host device 200 may set an idle period corresponding to the state of the memory 110 and transmit, to the storage device 100, an idle mode control signal according to the set idle period.

In addition, the host device 200 may transmit, according to the device information of the storage device 100, the idle mode control signal after transmitting a sleep mode setting signal depending on a state of the memory 110.

An idle mode control signal with an idle period set according to the time required for the memory 110 to perform the operation in the idle mode and to perform the operation in response to an internal command may be transmitted to the storage device 100. Alternatively, an idle mode control signal preceded by a sleep mode setting signal may be transmitted to the storage device 100.

Since the idle mode and the sleep mode may be controlled according to the state of the memory 110 included in the storage device 100, the operating efficiency of the storage device 100 may be improved.

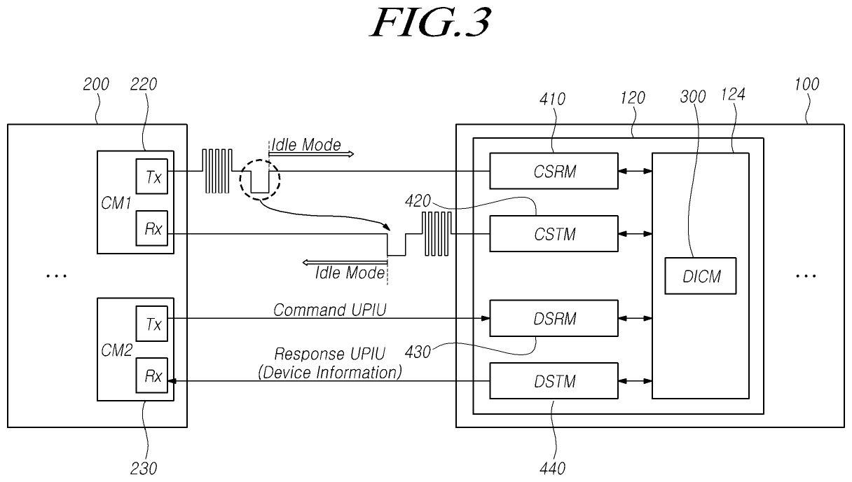

FIGS. 3 to 5 illustrate examples in which a storage device 100 according to embodiments of the present disclosure operates in the idle mode.

Referring to FIG. 3, a command unit may be transmitted to the data signal reception module 430 of the storage device 100 by the second communication module 230 of the host device 200. A response unit including the device information may be transmitted to the second communication module 230 of the host device 200 by the data signal transmission module 440 of the storage device 100.

The device information may be set by the device information configuration module 300. The device information may include information of the state of the memory 110. The state may be associated with at least one operation of the memory 110 performed by an internal command during an idle period.

The host device 200 may set an idle period based on the device information received from the storage device 100. The host device 200 may transmit, to the control signal reception module 410 of the storage device 100, an idle mode control signal according to the idle period.

For example, the host device 200 may transmit a control signal in the form of a pulse to the storage device 100 through the first communication module 220 while transmitting a command unit or the like to the storage device 100.

The host device 200 may transmit a signal in the form of a constant voltage to the storage device 100 after transmitting a signal instructing entry into the idle mode in the idle mode.

The control response signal transmission module 420 of the storage device 100 may transmit an idle mode control response signal to the first communication module 220 of the host device 200 in response to the idle mode control signal received from the host device 200. A signal of constant voltage may be transmitted and received between the first communication module 220 of the host device 200 and the control signal transmission/reception module of the storage device 100 in the idle mode.

The idle period according to the idle mode control signal may be set differently according to the device information.

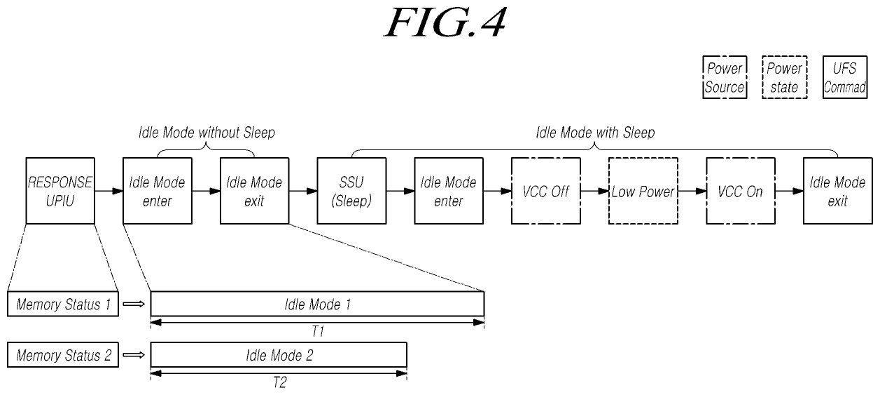

For example, referring to FIG. 4, if the state of the memory 110 according to the device information included in the response unit transmitted by the storage device 100 is a first state information (Memory Status 1), the idle period according to the idle mode control signal may be T1. If the state of the memory 110 according to the device information is a second state information (Memory Status 2), the idle period according to the idle mode control signal may be T2.

In this case, T1 and T2 may be different, and for example, T1 may be greater than T2. In this case, the state of the memory 110 according to the first state information (Memory Status 1) may represent a state in which a period required for performing an operation by an internal command is longer than the state of the memory 110 represented by the second state information (Memory Status 2).

Since the idle period is set in consideration of the state of the memory 110, when the idle period according to the idle mode control signal ends, the host device 200 may transmit a new idle mode control signal to the storage device 100.

The host device 200 may transmit a sleep mode setting signal to the storage device 100 before transmitting a new idle mode control signal. A control signal in the form of a pulse may be transmitted to the storage device 100 by the first communication module 220 of the host device 200 while transmitting the sleep mode setting signal.

After the sleep mode setting signal is transmitted by the host device 200, a new idle mode control signal may be transmitted to the storage device 100. According to the new idle mode control signal, at least one driving voltage supplied to drive the memory 110 included in the storage device 100 may be interrupted in the idle mode.

For example, the supply of VCC power used for the operation of the memory 110 may be interrupted. The storage device 100 may maintain a low power state during an idle period according to the new idle mode control signal.

The idle period according to the new idle mode control signal may be randomly set, may be set as a fixed period, or, in some cases, may not be set. The host device 200 may maintain an idle mode until transmission of a new command unit occurs.

Before the end of the idle mode, the supply of VCC power to the memory 110 may be recovered and the idle mode may end. Since the storage device 100 operates in an idle mode according to an idle period set to correspond to the state of the memory 110, the idle mode may be efficiently operated.

In addition, if the idle mode according to the corresponding idle period ends, the storage device 100 may operate in an idle mode in which a sleep mode is set, thereby reducing power consumption of the storage device 100.

In addition, depending on the state of the memory 110, the storage device 100 may immediately operate in an idle mode in which a sleep mode is set.

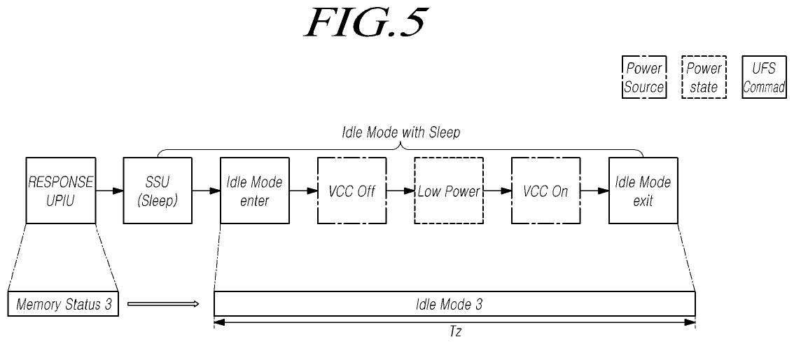

For example, referring to FIG. 5, the state of the memory 110 according to the device information included in the response unit transmitted by the storage device 100 may be third state information (Memory Status 3). The third state information (Memory Status 3) may represent, for example, a state in which an operation of the memory 110 by an internal command is hardly required during an idle period.

In this case, the host device 200 may transmit a sleep mode setting signal to the storage device 100 before transmitting the idle mode control signal. The sleep mode setting signal may be transmitted to the storage device 100, and then the idle mode control signal may be transmitted.

An idle period Tz according to the idle mode control signal transmitted after the sleep mode setting signal may be set randomly, may be a fixed period, or may be an unset period.

Since the sleep mode setting signal is transmitted before the transmission of the idle mode control signal to stop supplying at least a part of the power used for the operation of the memory 110, the power consumption of the storage device 100 may be efficiently managed. In addition, since the storage device 100 enters an idle mode with a set sleep mode if the storage device 100 does not have any operation to perform in response to an internal command, power consumption of the storage device 100 may be managed without affecting operating performance by an internal command.

As in the above example, the device information may include information on at least one of a remaining capacity of a write booster buffer, a dirty level for garbage collection, and a state of the memory 110 associated with an operation by an internal command. The idle period of an idle mode may be set corresponding to the device information.

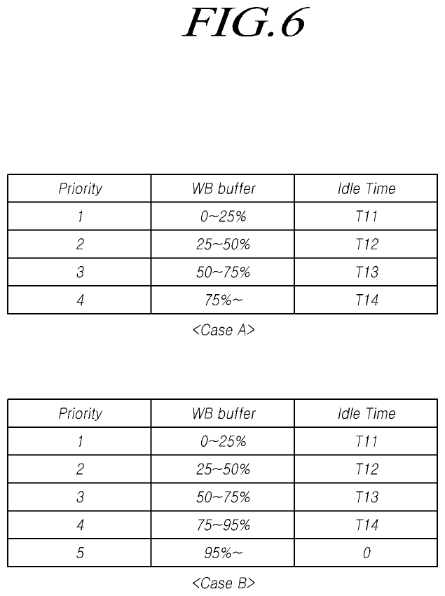

FIGS. 6 to 9 illustrate examples of a type of the device information transmitted by a storage device 100 and an idle period based on the device information according to embodiments of the present disclosure.

Referring to FIG. 6, as an example, an idle period of an idle mode may be set according to a remaining capacity of a write booster buffer.

For example, referring to <Case A>, if the remaining capacity of the write booster buffer is 25% or less, the idle period may be set to T11. If the remaining capacity of the write booster buffer is greater than 25% and less than 50%, the idle period may be set to T12. If the remaining capacity of the write booster buffer is 50˜75% and 75% or more, the idle period may be set to T13 and T14, respectively.

The magnitude relationship of T11, T12, T13, and T14 may be T11>T12>T13>T14.

As the remaining capacity of the write booster buffer decreases, a time required for moving data in the write booster buffer may increase. Therefore, a length of the idle period may be set in inverse proportion to the remaining capacity of the write booster buffer.

In addition, if the movement of data in the write booster buffer is hardly required, the idle period may be set to “0”.

For example, referring to <Case B>, if the remaining capacity of the write booster buffer is 75 to 95%, the idle period may be set to T14. If the remaining capacity of the write booster buffer is 95% or more, the idle period may be set to “0”. If the idle period is set to “0”, the storage device 100 may be controlled according to the idle mode preceded by the sleep mode setting signal.

In the case that the need is low to move data in the write booster buffer, it is possible to reduce the power consumption of the storage device 100 by operating in an idle mode in which a sleep mode is set.

As another example, an idle period according to an idle mode may be set according to a dirty level included in the device information.

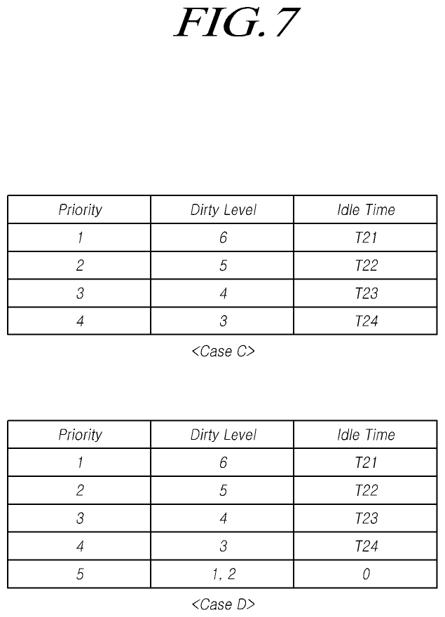

Referring to <Case C> of FIG. 7, if the dirty level is 6, the idle period may be set to T21. If the dirty levels are 5, 4, and 3, the idle periods may be set to T22, T23, and T24, respectively.

The magnitude relationship of T21, T22, T23, and T24 may be T21>T22>T23>T24.

Since a length of time required to perform garbage collection may increase as the dirty level corresponding to a level at which garbage collection is required increases, the idle period may be set in proportion to the dirty level.

The idle mode of the storage device 100 may be controlled according to an idle mode control signal in which an idle period according to a dirty level is set.

In addition, in the case that the dirty level is equal to or less than a specific level, the idle period may be set to “0”.

For example, referring to <Case D> of FIG. 7, if the dirty level is 1 or 2, the idle period may be set to “0”. If the idle period is set to “0”, the host device 200 may transmit an idle mode control signal to the storage device 100 after transmitting a sleep mode setting signal.

In the case that a need for garbage collection is low, the storage device 100 may operate in an idle mode in which a sleep mode is set.

In addition, the device information may include both the remaining capacity of the write booster buffer and the dirty level, and an idle period may be set according to each piece of the device information.

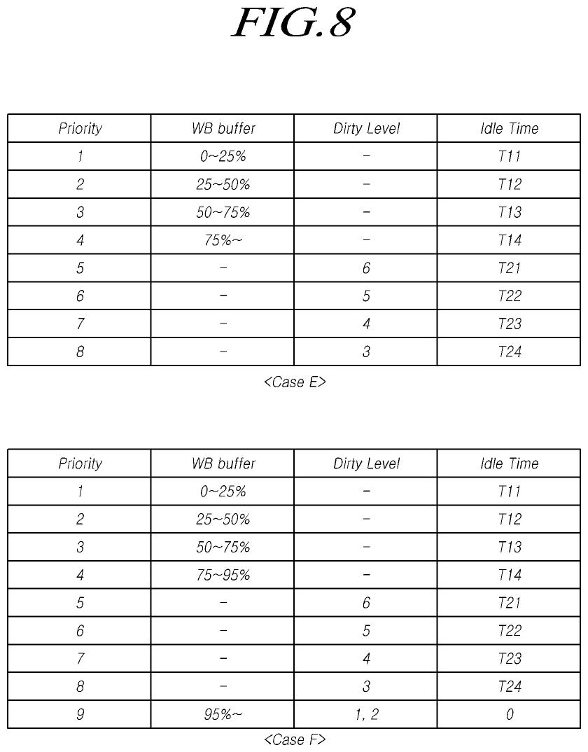

As an example, referring to <Case E> of FIG. 8, if the remaining capacity of the write booster buffer is 0 to 25%, 25 to 50%, 50 to 75%, and 75% or more, the idle period may be set to T11, T12, T13, and T14, respectively. The magnitude relationship among T11, T12, T13, and T14 may be T11>T12>T13>T14.

If the dirty levels are 6, 5, 4, and 3, the idle periods may be set to T21, T22, T23, and T24, respectively. The magnitude relationship among T21, T22, T23, and T24 may be T21>T22>T23>T24.

Although the example shown in FIG. 8 illustrates that the priorities of the remaining capacity of the write booster buffer are higher than the priorities of the dirty level, an idle period set according to the dirty level may be larger or smaller than an idle period set according to the remaining capacity of the write booster buffer.

In the case that the device information includes information on the remaining capacity of the write booster buffer or dirty level, an idle period may be set according to the corresponding information.

If the device information includes both information on the remaining capacity of the write booster buffer and the dirty level, an idle period may be set as the sum of the idle periods corresponding to each of information. Alternatively, the idle period may be set to a larger value among idle periods corresponding to each piece of information. Alternatively, the idle period may be set to a value between idle periods corresponding to each piece of information.

The idle period may be set in various ways depending on whether an operation of moving data in the write booster buffer and garbage collection are performed separately or simultaneously.

In addition, a case in which the idle period is “0” may be set according to information of the write booster buffer and the dirty level.

For example, referring to <Case F>, if the remaining capacity of the write booster buffer is 95% or more and the dirty level is 1 or 2, the idle period may be set to “0”. In a state in which an operation of moving data in the write booster buffer or an operation according to garbage collection is not required, the storage device 100 may operate in the idle mode in which the sleep mode is set by setting the idle period to “0”.

As described above, the device information may include state information according to two or more status types, and an idle period may be set according to each state information.

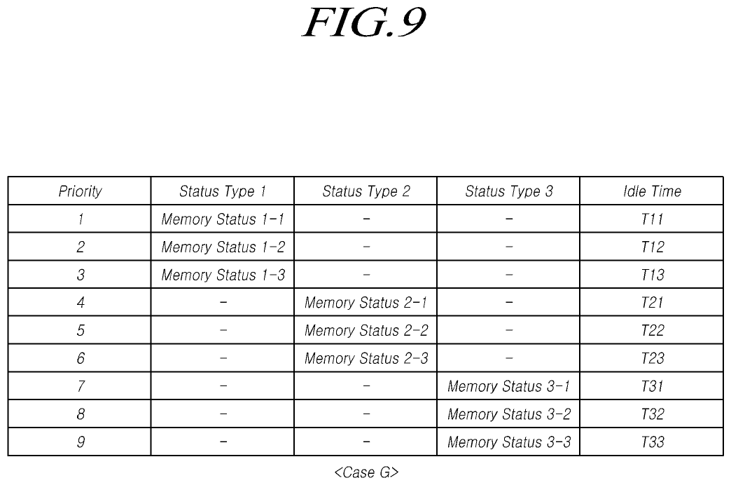

Referring to <Case G> in FIG. 9, three status types are illustrated.

The device information may include state information for each of the three status types (Status Type 1, Status Type 2, and Status Type 3) of the memory 110.

For example, three types of state information (Memory Status 1-1, 1-2, and 1-3) may be set for a first status type. The idle period according to the three pieces of state information (Memory Status 1-1, 1-2, 1-3) may be set to T11, T12, and T13, where T11>T12>T13.

Three types of state information (Memory Status 2-1, 2-2, 2-3) may be set for a second status type. The idle period according to the three pieces of state information (Memory Status 2-1, 2-2, 2-3) may be set to T21, T22, and T23, where T21>T22>T23.

Three types of state information (Memory Status 3-1, 3-2, and 3-3) may be set for a third status type. The idle period according to the three pieces of state information (Memory Status 3-1, 3-2, 3-3) may be set to T31, T32, and T33, where T31>T32>T33.

In the same status type, the idle period may be set to a value that gradually increases or decreases according to state information. In other status types, the idle period may be set in various ways.

The idle period may be set according to state information about a status type associated with each of a plurality of operations of the memory 110 performed according to an internal command in the idle period.

The idle periods may be variously set according to various state information for various status types. When the idle period according to the idle mode ends, the storage device 100 may enter an idle mode in which a sleep mode is set. The idle period for an operation serving an internal command may be efficiently managed, thereby reducing the power consumption of the storage device 100.

The device information indicating the state of the memory 110 may be transmitted in various ways. For example, the device information may be transmitted through some fields of the device information included in a response unit.

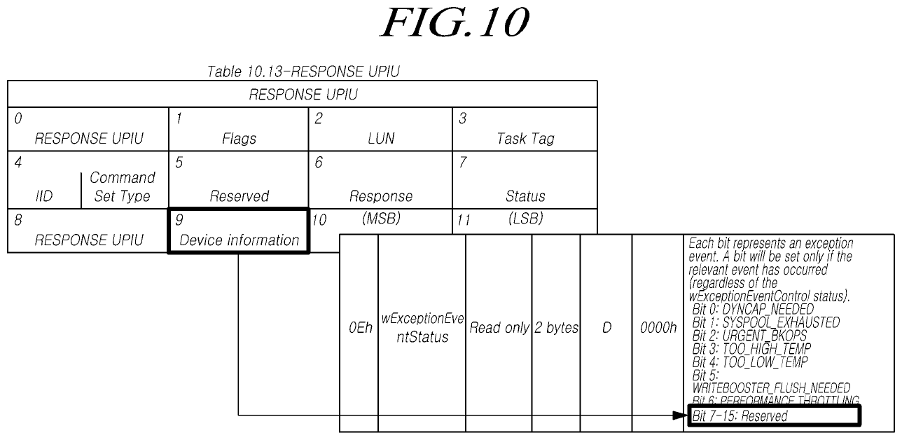

FIG. 10 illustrates an example of a method of transmitting the device information by a storage device 100 according to embodiments of the present disclosure.

Referring to FIG. 10, the device information indicating a state of the memory 110 may be transmitted using some bits of an exception event status field included in a response unit. For example, the device information may be transmitted through bits 7 to 15 (8th to 16th bits) of the exception event status field. Bits 7 to 15 of the exception event status field are reserved and may be used to transmit the device information for setting an idle period.

The controller 120 may set a bit value of the exception event status field to a specific value (e.g., “1”) if it is required to set the exception event status field according to the state of the memory 110.

For example, the controller 120 may set bit of the exception event status field to a specific value if the remaining capacity of the write booster buffer is 25% or less when a write booster flush enable flag is turned on. The controller 120 may set bit [9] of the exception event status field to a specific value if the write booster flush enable flag is turned on and the remaining capacity of the write booster buffer is 50% or less. The controller 120 may set bit [8] of the exception event status field to a specific value if the remaining capacity of the write booster buffer is 75% or less when the write booster flush enable flag is turned on. The controller 120 may set bit [7] of the exception event status field to a specific value if the remaining capacity of the write booster buffer exceeds 75%.

Alternatively, the controller 120 may set bits [7], [8], [9] and of the exception event status field to specific values if the dirty level is 3, 4, 5, and 6, respectively.

A length of the idle period may increase as it goes to bits [7], [8], [9], and of the exception event status field.

Alternatively, bits [7], [8], [9], and of the exception event status field may be set according to the remaining capacity of the write booster buffer, and bits [11], [12], [13], and of the exception event status field may be set according to the dirty level.

In addition, in some cases, bit of the exception event status field may be used to indicate that the Idle mode, which may be preceded by sleep modes according to the remaining capacity of the write booster buffer (e.g., 95% or more) and the dirty level (e.g., level 1 or 2).

The host device 200 may check bits of the exception event status field and set an idle period of the idle mode according to a set value of the exception event status field.

The host device 200 may control the idle mode of the storage device 100 by transmitting an idle mode control signal according to a set idle period to the storage device 100.

The storage device 100 may perform an operation of the memory 110 performed by an internal command during an idle period set according to an idle mode. When the idle period ends, the storage device 100 may receive a new idle mode control signal after receiving a sleep mode setting signal. The storage device 100 may operate in a sleep mode during an idle period according to the new idle mode control signal. The supply of at least a part of the power to the memory 110 may be interrupted.

An operation may be performed in response to an internal command during an idle period set according to the state of the memory 110, and the storage device 100 may operate in an idle mode in which a sleep mode is set after the operation is completed in response to the internal command, thereby reducing the power consumption of the storage device 100.

Based on embodiments of the disclosed technology described above, the operation delay time of the memory system may be advantageously reduced or minimized. In addition, based on an embodiment of the disclosed technology, an overhead occurring in the process of calling a specific function may be advantageously reduced or minimized. Although various embodiments of the disclosed technology have been described with particular specifics and varying details for illustrative purposes, those skilled in the art will appreciate that various modifications, additions and substitutions may be made based on what is disclosed or illustrated in the present disclosure without departing from the spirit and scope of the invention as defined in the following claims. Furthermore, the embodiments may be combined to form additional embodiments.

What is claimed is:

1. A storage device comprising:
a memory; and
a controller configured to:
control an operation of the memory according to an external command or an internal command,
set device information based on a state of the memory, the state being associated with the operation according to the internal command,
transmit the device information to an external device, and
receive an idle mode control signal corresponding to the device information.

2. The storage device of claim 1,
wherein the device information is one of first state information and second state information,
wherein the idle mode control signal indicates an idle period of the storage device, and
wherein the idle period corresponding to the first state information is different from the idle period corresponding to the second state information.

3. The storage device of claim 1, wherein the state of the memory is a remaining capacity of a write booster buffer included in the memory.

4. The storage device of claim 1,
wherein the idle mode control signal indicates an idle period of the storage device, and
wherein the idle period is inversely proportional to a remaining capacity of the write booster buffer.

5. The storage device of claim 1, wherein the controller is further configured to receive a sleep mode setting signal before the idle mode control signal when a remaining capacity of a write booster buffer included in the memory is equal to or greater than a preset value.

6. The storage device of claim 1, wherein the state of the memory is a level at which garbage collection is required for the memory.

7. The storage device of claim 1,
wherein the idle mode control signal indicates an idle period of the storage device, and
wherein the idle period is proportional to a level at which garbage collection is required for the memory.

8. The storage device of claim 1, wherein the controller is further configured to receive a sleep mode setting signal before the idle mode control signal when a level at which garbage collection is required for the memory is less than or equal to a preset level.

9. The storage device of claim 1,
wherein the idle mode control signal indicates an idle period of the storage device, and
wherein the controller is further configured to receive a sleep mode setting signal when the idle period ends.

10. The storage device of claim 9, wherein the controller is further configured to stop, when receiving the idle mode control signal subsequently provided after the sleep mode setting signal, a supply of at least one operating voltage to the memory during the idle period corresponding to the subsequent idle mode control signal.

11. The storage device of claim 1, wherein the controller transmits the device information through one or more bits included in an exception event status field included in a response unit transmitted to the external device.

12. The storage device of claim 11, wherein the one or more bits are at least a part of 8th to 16th bits among 16 bits included in the exception event status field.

13. The storage device of claim 11, wherein the controller is further configured to receive a sleep mode setting signal before the idle mode control signal when the one or more bits are not set or all the one or more bits are set to the same value.

14. The storage device of claim 1, wherein the controller is further configured to transmit an idle mode control response signal to the external device during the receiving of the idle mode control signal.

15. A computing system comprising:
a storage device configured to:
control, according to an external command or an internal command, an operation of a memory included therein,
set device information based on a state of the memory, the state being associated with the operation according to the internal command, and
transmit the device information to a host device; wherein the host device configured to:
set an idle period corresponding to the device information, and
transmit, to the storage device, an idle mode control signal indicating the idle period.

16. The computing system of claim 15, wherein the host device is further configured to provide, when the idle period ends, the storage device with a sleep mode setting signal and then with a subsequent idle mode control signal.

17. The computing system of claim 15,
wherein the device information includes one or more bits indicating the state, and
wherein the host device is further configured to provide, when the one or more bits are not set or all the one or more bits are set to the same value, the storage device with a sleep mode setting signal before the transmission of the idle mode control signal.

18. The computing system of claim 17, wherein the host device sets the idle time to a random value of a non-fixed value when providing the storage device with the sleep mode setting signal before the transmission of the idle mode control signal.

19. A controller comprising:
a device information configuration module configured to set device information based on a state of a memory, the state being associated with an operation of the memory and the operation being performed according to an internal command;
a data signal transmission module configured to transmit the device information to an external device; and
a control signal reception module configured to receive an idle mode control signal corresponding to the device information.

20. The controller of claim 19, further comprising a control response signal transmission module configured to transmit, in response to the idle mode control signal, an idle mode control response 5 signal to the external device.
